(19) United States
(12) Patent Application Publication
(10) Pub. No.: US 2022/0415304 A1
(43) Pub. Date: Dec. 29, 2022

(54) NEURAL NETWORK MEMORY FOR AUDIO

(71) Applicant: Amazon Technologies, Inc., Seattle, WA (US)

(72) Inventors: Sri Vishnu Kumar KARLAPATI, Cambridge (GB); Panagiota KARANASOU, Cambridge (GB); Arnaud Vincent Pierre Yves JOLY, Cambridge (GB); Alexis Pierre MOINET, Cambridge (GB); Thomas Renaud DRUGMAN, Carnieres (BE); Petr MAKAROV, Cambridge (GB); Bajibabu BOLLEPALLI, Cambridge (GB); Syed Ammar ABBAS, Cambridge (GB); Simon SLANGEN, Edinburgh (GB)

(21) Appl. No.: 17/357,585

(22) Filed: Jun. 24, 2021

(51) Int. Cl. G10L 13/08; G10L 15/183; G10L 15/16

(52) U.S. Cl. CPC G10L 13/08; G10L 15/183; G10L 15/16

(57) ABSTRACT

Techniques for utilizing memory for a neural network are described. For example, some techniques utilize a plurality of memory types to respond to a query from a neural network including a short-term memory to store fine-grained information for recent text of a document and receiving a first value in response, an episodic long-term memory to store information discarded from the short-term memory in a compressed form and receiving a second value in response, and a semantic long-term memory to store relevant facts per entity in the document.

### BACKGROUND

For the oral recitation of text, the narrator determines the prosody of speech based on various things introduced in the book and this includes, scenarios, scenes, the presence of characters, characteristics of the character and so on. The narrator is able to remember these things and later use them in their narration. Thus, from a memory perspective, the narrator is writing to their memory information about the book being read so far, to later recollect it to determine the prosody with which they render the book. This can range from something as simple as maintaining a proper transition of prosody between sentences, to remembering that a certain character had a certain peculiar prosody about them which needs to be used every time a dialogue by that speaker is encountered.

### BRIEF DESCRIPTION OF DRAWINGS

Various embodiments in accordance with the present disclosure will be described with reference to the drawings, in which:

FIG. 1 illustrates embodiments of one or more systems utilizing neural network memory having multiple different types of memory.

FIG. 2 illustrates embodiments of a device utilizing neural network memory having multiple different types of memory.

FIG. 3 illustrates embodiments of a neural network memory system.

FIG. 4 illustrates embodiments of the short-term memory manager and short-term memory.

FIG. 5 illustrates embodiments of the short-term memory manager.

FIG. 6 is a flow diagram illustrating operations of a method for using memory in neural networks to maintain state according to some embodiments.

FIG. 7 is a flow diagram illustrating operations of a method for maintaining short-term memory according to some embodiments.

FIG. 8 is a flow diagram illustrating operations of a method for maintaining episodic memory according to some embodiments.

FIG. 9 is a flow diagram illustrating operations of a method for training episodic memory according to some embodiments.

FIG. 10 is a flow diagram illustrating operations of a method for maintaining semantic memory according to some embodiments.

FIG. 11 illustrates an example provider network environment according to some embodiments.

FIG. 12 is a block diagram of an example provider network environment that provides a storage service and a hardware virtualization service to customers, according to some embodiments.

FIG. 13 is a block diagram illustrating an example computer system that can be used in some embodiments.

### DETAILED DESCRIPTION

The present disclosure relates to methods, apparatus, systems, and non-transitory computer-readable storage media for using memory for speech processing neural networks. Current systems are designed based on the assumption that a single sentence has enough information to determine the prosody of an entire sentence. This is irrespective of the technology used. This assumption is clearly flawed as a variety of additional information available is ignored. The methods that have looked at paragraph-level tried re-using existing methods with more text. Such methods have the limitation of modelling capacity as there are no explicit components allowing the model to look at context beyond the sentence. Thus, looking into ways of tapping into, “memory” and maintaining important contextual information over time, is an important problem.

While adding memory to neural networks to maintain state over extended periods of time has existed, such as simple linear memory cells like LSTMs to more advanced systems like memory augmented neural networks, described herein are novel and non-obvious approaches to adding/using memory for neural components, in the following way by having multiple memory types (short-term (also called working memory), long-term episodic, and long-term semantic).

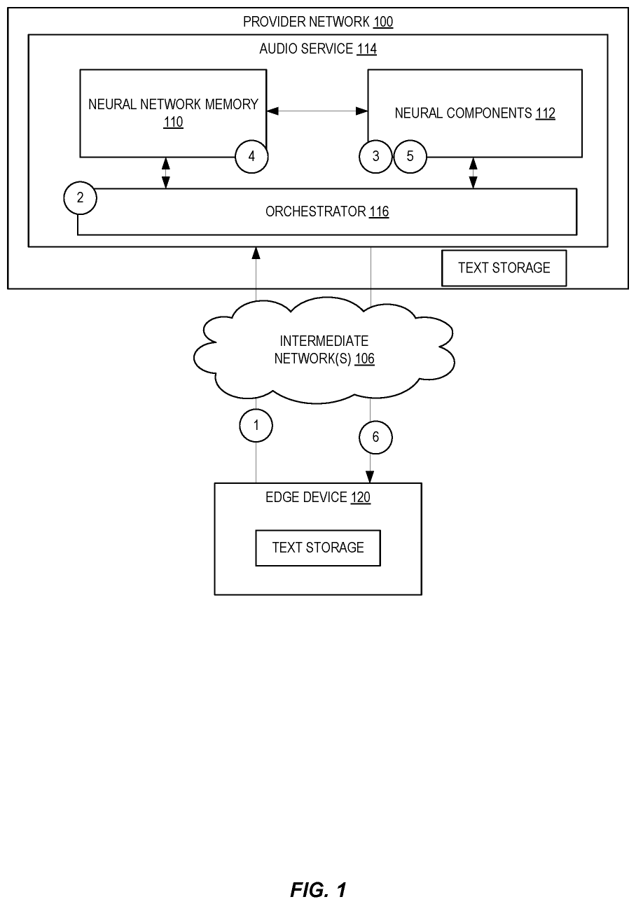

FIG. 1 illustrates embodiments of one or more systems utilizing neural network memory having multiple different types of memory. In this illustration, an audio service 114 allows for a user to interact with neural components 112 to generate audio from text (stored either in the provider network 100 or in an edge device 120). Neural components 112 include, but are not limited to, one or more of acoustic models, language models, pronunciation models, etc. For example, neural components 112 perform text-to-speech that model prosody (e.g., intonation, stress, and rhythm) for a speaker for a given piece of text.

The audio service 114 utilizes an orchestrator 116 to handle one or more of incoming requests for audio generation from text, communication between the neural network memory 110 and neural components 112, etc. The neural network memory 110 uses one or more types of memory: short-term memory, episodic memory, and/or semantic memory which are discussed in greater detail below.

The provider network 100 (or, “cloud” provider network) provides users with the ability to use one or more of a variety of types of computing-related resources such as compute resources (e.g., executing virtual machine (VM) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (CDNs), Domain Name Service (DNS)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users (or “customers”) of provider networks 100 can use one or more user accounts that are associated with a customer account, though these terms can be used somewhat interchangeably depending upon the context of use. Users can interact with a provider network 100 across one or more intermediate networks 106 (e.g., the internet) via one or more interface(s), such as through use of application programming interface (API) calls, via a console implemented as a website or application, etc. An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another. The interface(s) can be part of, or serve as a front-end to, a control plane of the provider network 100 that includes “backend” services supporting and enabling the services that can be more directly offered to customers.

For example, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

A cloud provider network can be formed as a number of regions, where a region is a geographical area in which the cloud provider clusters data centers. Each region includes multiple (e.g., two or more) availability zones (AZs) connected to one another via a private high-speed network, for example a fiber communication connection. An AZ (also known as an availability domain, or simply a “zone”) provides an isolated failure domain including one or more data center facilities with separate power, separate networking, and separate cooling from those in another AZ. A data center refers to a physical building or enclosure that houses and provides power and cooling to servers of the cloud provider network. Preferably, AZs within a region are positioned far enough away from one another so that a natural disaster (or other failure-inducing event) should not affect or take more than one AZ offline at the same time.

Customers can connect to an AZ of the cloud provider network via a publicly accessible network (e.g., the Internet, a cellular communication network), e.g., by way of a transit center (TC). TCs are the primary backbone locations linking customers to the cloud provider network and can be collocated at other network provider facilities (e.g., Internet service providers (ISPs), telecommunications providers) and securely connected (e.g., via a VPN or direct connection) to the AZs. Each region can operate two or more TCs for redundancy. Regions are connected to a global network which includes private networking infrastructure (e.g., fiber connections controlled by the cloud provider) connecting each region to at least one other region. The cloud provider network can deliver content from points of presence (or “POPs”) outside of, but networked with, these regions by way of edge locations and regional edge cache servers. This compartmentalization and geographic distribution of computing hardware enables the cloud provider network to provide low-latency resource access to customers on a global scale with a high degree of fault tolerance and stability.

To provide these and other computing resource services, provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code—typically without the user having any control of or knowledge of the underlying compute instance(s) involved.

For example, in various embodiments, a “serverless” function can include code provided by a user or other entity—such as the provider network itself—that can be executed on demand. Serverless functions can be maintained within a provider network by an on-demand code execution service, and can be associated with a particular user or account, or can be generally accessible to multiple users/accounts. A serverless function can be associated with a Uniform Resource Locator (URL), Uniform Resource Identifier (URI), or other reference, which can be used to invoke the serverless function. A serverless function can be executed by a compute resource, such as a virtual machine, container, etc., when triggered or invoked. In some embodiments, a serverless function can be invoked through an application programming interface (API) call or a specially formatted HyperText Transport Protocol ( ) request message. Accordingly, users can define serverless functions that can be executed on demand, without requiring the user to maintain dedicated infrastructure to execute the serverless function. Instead, the serverless functions can be executed on demand using resources maintained by the provider network 100. In some embodiments, these resources can be maintained in a “ready” state (e.g., having a pre-initialized runtime environment configured to execute the serverless functions), allowing the serverless functions to be executed in near real-time.

The circles with numbers inside indicate an exemplary flow. At circle 1, an edge device 120 makes a request to have text converted to audio (speech). The text may be as simple as a few paragraphs or as complex as book (or volume of books such as a series of books). The edge device 120 typically has an application running that makes this request.

The orchestrator 116 receives the requests at circle 2 and calls the neural components 112 to start generating audio for the text. At circle 3 the neural components 112 start the audio generation process. As a part of the process, the neural components 112 send one or more queries at circle 4 to neural network memory 110 which retain information about the text, etc.

The neural components 112 use the results of the queries in the generation of audio at circle 5. At circle 6 the audio is returned to the edge device.

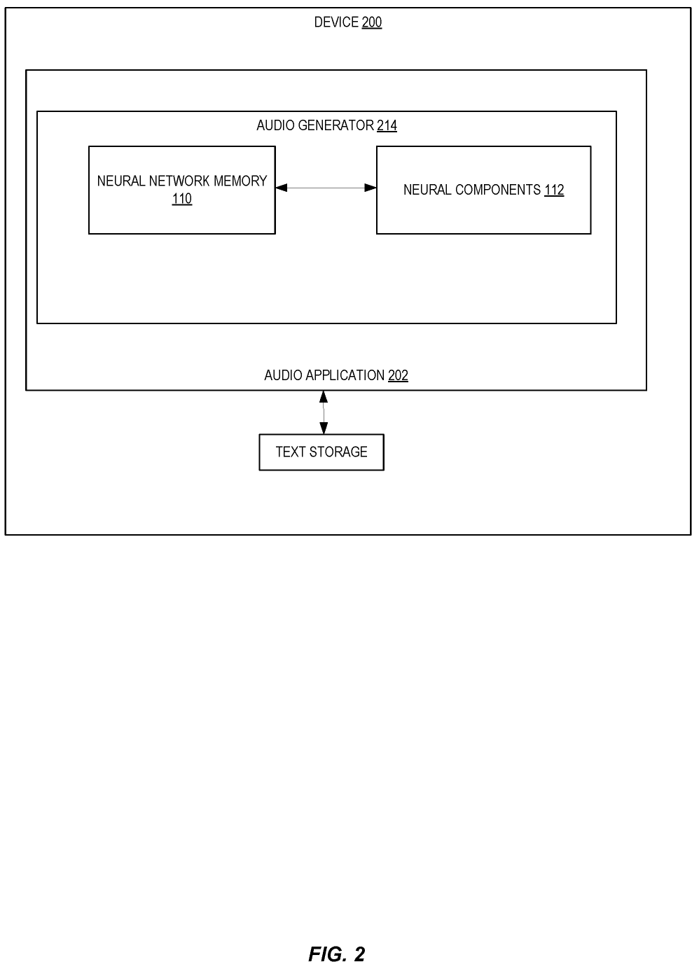

FIG. 2 illustrates embodiments of a device 200 utilizing neural network memory 110 having multiple different types of memory. In this illustration, an audio generator 214 allows for an audio application 202 to use neural components 112 to generate audio from text. Neural components 112 include, but are not limited to, one or more of acoustic models, language models, pronunciation models, etc. For example, neural components 112 perform text-to-speech that model prosody (e.g., intonation, stress, and rhythm) for a speaker for a given piece of text. The neural network memory 110 uses one or more types of memory: short-term memory, episodic memory, and/or semantic memory which are discussed in greater detail below.

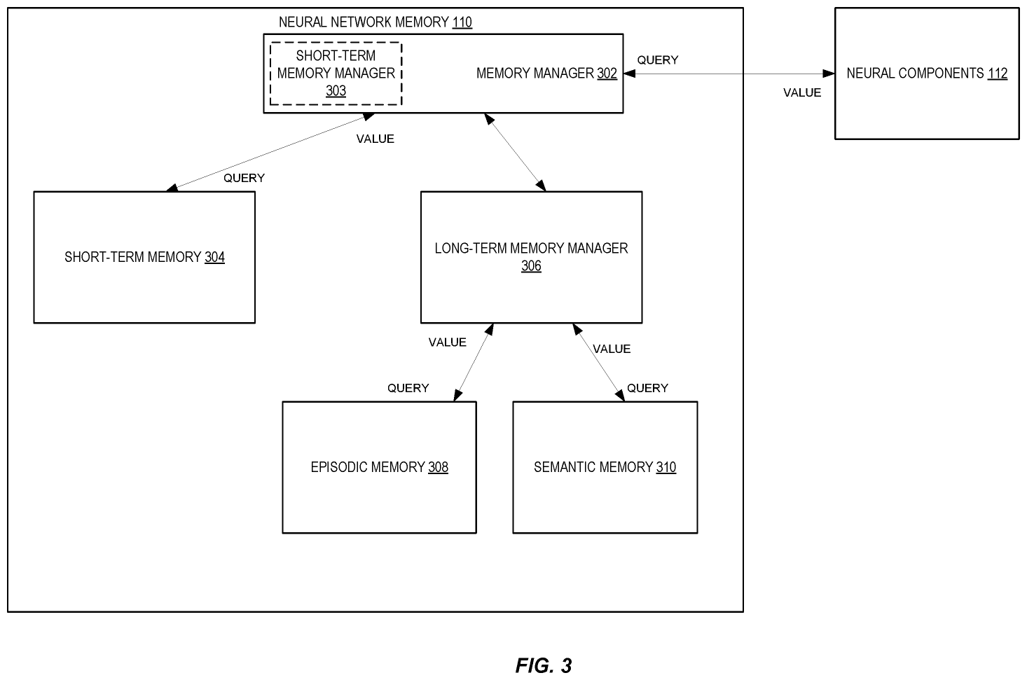

FIG. 3 illustrates embodiments of a neural network memory system. In some embodiments, this neural network memory system is the neural network memory 110 of FIG. 1. As shown, the neural network memory system includes one or more types of memory: short-term memory 304, episodic memory 308, and/or semantic memory 310. Note that when discussing these memories, where those types of memory are located (e.g., volatile memory such random-access memory (RAM) or non-volatile memory) is not of particular importance. The desired efficiency (e.g., power, latency, etc.), availability, etc. will usually inform as to where these memories will be physically located.

In neural network memory system, there is at least one memory manager which handles queries to one or more of the memory types, maintains one or more memory types, and/or trains one or more of the memory types. In this example, there is an overall memory manager 302 which receives queries (such as from neural components 112) and responses with a predicted answer from one or more of the memory types. Note that the functionality of the long-term memory manager 306 is included in the memory manager 302 in some embodiments.

The memory manager 302 has at least two jobs. First, it interacts with other neural components 112. As such, it receives a query and returns one or more value(s) to the external neural components 112. The received query is searched for in the short-term memory 304 and in the long-term memories (episodic memory 308 and semantic memory 310). The memory manager 302 also combines (e.g., concatenates) results from the queries before returning them.

Second, the memory manager 302 (via short-term memory manager 303) maintains the short-term memory 304. When the short-term memory 304 is full the memory manager 302 takes information evicted out of the short-term memory 304 and provides it to the long-term memory controller 306 for storage. How, or if, it is stored is left to the long-term memory controller 306. Note that evicted information may include text and/or keys.

The short-term memory 304 retains recent information in a fine-grained state. As most systems are resource limited, all of the sentences (e.g., the entire book) from document are typically not stored this memory. For example, if an entire book was stored in short-term memory 304, there would likely be issues when computing a probability distribution over several keys and these issues will be linearly exacerbated as per the number of potential keys. Thus, in some embodiments, the amount of memory slots the short-term memory 304 has are limited, but allow it to store fine-grained information. The addition of information, and the removal of information from these memory slots, is controlled by the short-term memory manager 303.

There are multiple potential ways of storing and removing information in short-term memory 304. In some embodiments, the short-term memory 304 is managed using a heuristic storage methodology which may allow for greater interpretability. In this approach, each new information (e.g., sentence, etc.) is stored in a slot of the short-term memory 304 until all of the slots are filled. Upon getting full, the short-term memory manager 303 will use a caching storage algorithm such as first in, first out (FIFO), last in, first out (LIFO), least frequently used (LFU), least recently used (LRU), etc. to retain and evict information here. In some embodiments a probability distribution is computed over the candidates (slots) and the “expected usage” is used as a metric to determine retention.

In some embodiments, the short-term memory 304 is managed using a differentiable storage methodology. This approach allows for lesser interpretation compared to the heuristic storage methodology. Differentiable storage mimics the behavior of multiple “forgetting” machines like LSTMs, GRUs, and so on, by having a soft deletion of information. In essence, performing a calculation of a probability_of_usage*existing_element+(1−probability_of_usage)*incoming_element.

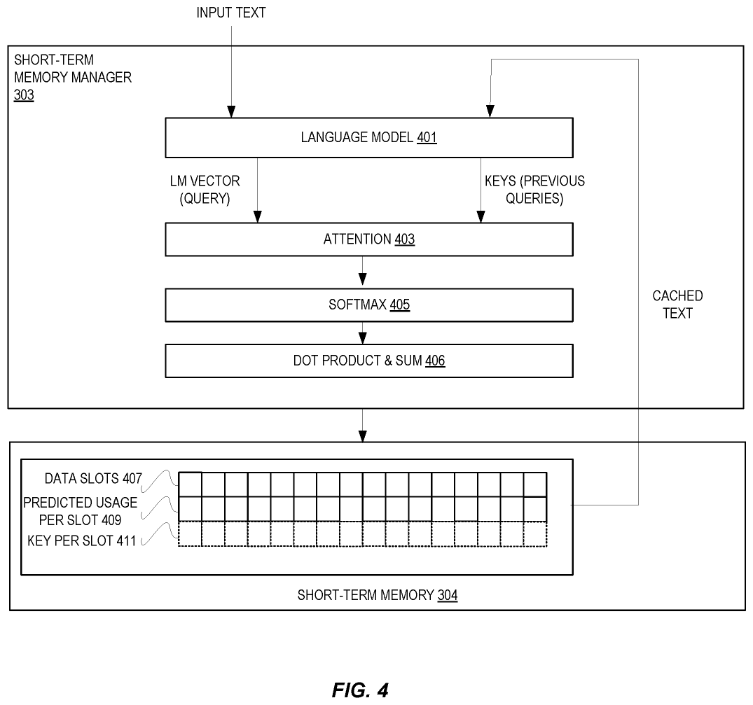

FIG. 4 illustrates embodiments of the short-term memory manager and short-term memory. As illustrated, the short-term memory manager 303 includes a language model 401 (e.g., BERT, etc.) and an attention-based aspect 403. The attention-based aspect 403 calculates weights representing relative importance (similarity) of inputs (keys) in a sequence for a particular output (query). The dynamic weights are subjected to a SoftMax function 405 and a dot product and sum 406 is applied to the weights and stored values (previous text) to generate a value. Note that a query is a vector including one or more of text, previous prosodic latents, previous phonemes, location information for the text (e.g., paragraph, chapter, page, etc.), etc.

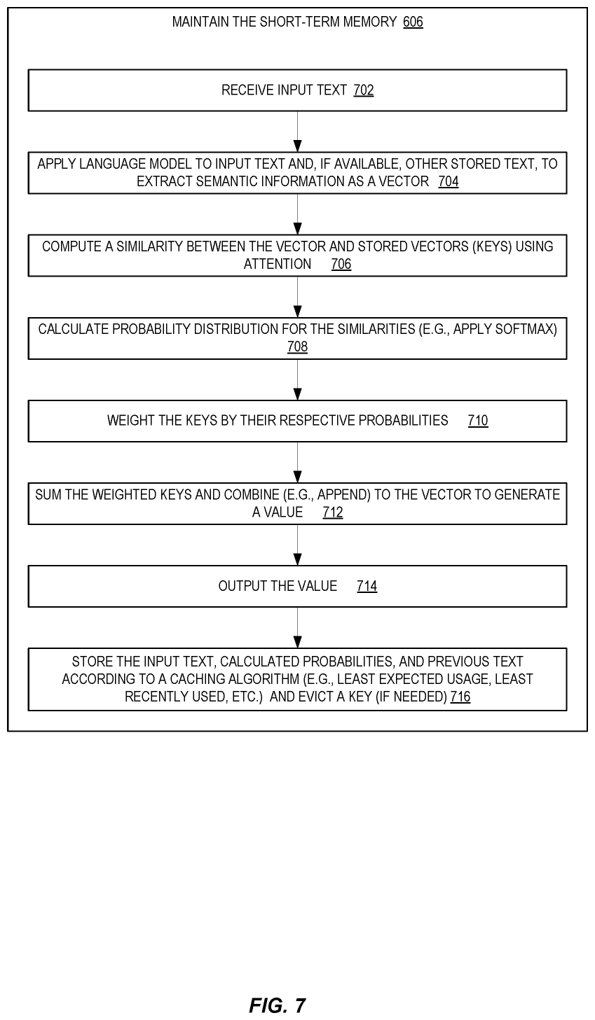

The short-term memory 304 itself stores the text of the query in data slots 407, a predicted usage per slot (text) 409, and, in some embodiments, a key per slot (text) 411. FIG. 7 details embodiments of maintaining the short-term memory 304 using the short-term memory manager 303.

Upon deletion (e.g., eviction) of information, that information is sent by the memory manager 302 to the long-term memory controller 306 for compression. The long-term memory manager 306 also performs one or more tasks. In some embodiments, the long-term memory manager 306 finds return value(s) for a query it receives from the memory manager 302 via query manager 504. For example, given a query, it looks up potential keys and then returns weighted value(s). It will look through both the episodic memory 308 and semantic memory 310.

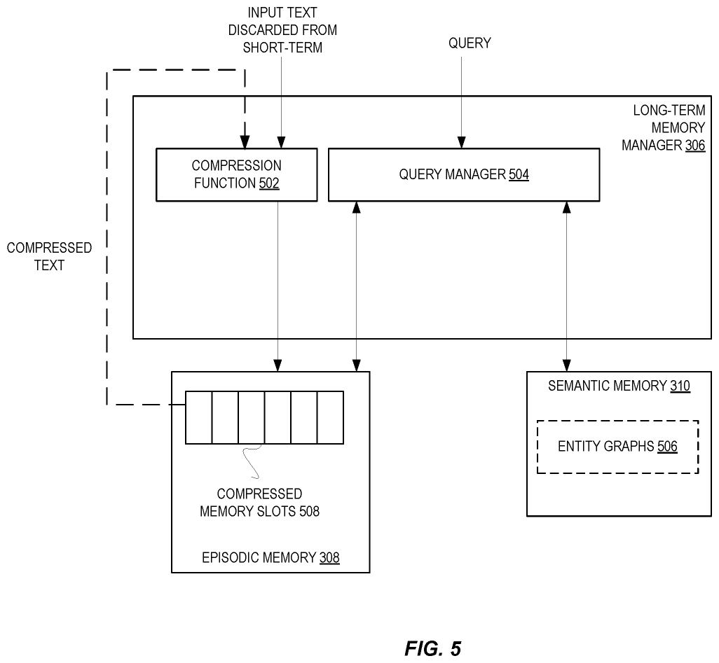

FIG. 5 illustrates embodiments of the short-term memory manager 306. The long-term memory manager 306 receives discarded short-term memory information (input text). Depending on the type of short-term memory storage the behavior may change. Episodic memory 308 includes collection of memory slots 508 to store discarded short-term information is stored in a compressed form using a compression function 502. In some embodiments, the compression is done in one or more ways. When incremental episodic memory is used, discarded short-term information is stored into a compressed representation. This works in a sequential manner. That is as “new” short-term data is to be stored, it is compressed along with previous compressed data. In some embodiments, a trainable compression function is used which takes as input the discarded information, and the previously compressed information, to generate a new compressed representation of information. In some embodiments, this is performed using an LSTM. In other embodiments, an attention-based mechanism (e.g., aspects of a transformer) is used. In some embodiments, a lossy reconstruction loss is utilized with an aim to recreate the previous short-term memory embeddings which were compressed.

When prior-constructed episodic memory is used, the source is “read” (parsed) entirely in a first read. Note this is different than how a human would typically approach text (one does not typically read from back or middle to front and, as such, does not have a priori knowledge). This may help with what could be jarring changings in the audio. For example, finding out that a character is from a certain area of the world would impact an accent and having a change of that accent when that is first discussed in a book would not lend itself to a cohesive reading. Certain memories are stored in a compressed form to be later re-used. This means that memories from latter parts of the book can be used when synthesizing speech for the earlier parts of the book. The storage again uses a compression function, which takes in a sequence of sentences, and provides a single compressed representation of them. This compressed representation is trained using the lossy reconstruction loss, where the representations of each of the sentences is reconstructed from this compressed representation.

The number of memory slots and where each compressed memory is stored is also determined in one of many different ways. In some embodiments, this is performed using a similarity-based mechanism. The similarity between the incoming short-term memory data and all the previously compressed memory slots is determined. The previously compressed memory slots are passed, along with the “new” memory from the short-term memory and the similarity scores, to a compression function, which stores some of the incoming short-term memory in all the memory slots. The degree of which depends on the similarity/dis-similarity between the compressed memory slots and the incoming short-term memory.

In some embodiments, a book heuristic-based approach is used. In this case, memories are stored in a more structured fashion. Outgoing memories that belong to a paragraph, a chapter, etc. are compressed together.

The above methods of storing information, can be used with the methods of compression, leading to multiple ways in which episodic memories can be organized.

Semantic memory 310 has each discarded sentence or clause go through, and if needed, stores information from the sentence or clause in a symbolic form. For example, if the discarded sentence is, “George Washington was a president of the USA”, then an Entity Relation tuple (Washington, president, USA) would be stored as a symbolic representation of the sentence. Many such rules can be extracted. In some embodiments, the rule extraction uses a pipeline such as resolving pronouns (resolve pronouns to match the entity that the pronoun is referring to), extract information regarding what the sentence has for relationships, the relations may or may not be of use in determining the prosody of a sentence, and in some embodiments at a relation filter is then applied which discards a sentence if the relationship in the sentence is not of use, and, finally, the remaining relations are stored in an entity relationship graph 506.

Upon receiving a query, all relevant facts surrounding the given entity in the query are found and returned to the neural component. These entities returned by the query had learned embeddings which are used in determining the prosody of synthesized speech. This can also be done in an incremental or prior built manner.

While building the base of facts is the possibility of a sudden realization of new facts which may result in invalidation of previous facts. In some embodiments, this is treated in different ways depending on the type of way in which we are building the base. For an incremental build, the new information is ignored if the fact it is invalidating has already been used or slowly interpolated in an embedding space between the old entity and the new entity in future sentences, resulting in a gradual transition in prosody.

For a prior built scenario, facts are not invalidated, but book timestamps are added to when the facts came into effect. This enables the model to make a decision on which one to use.

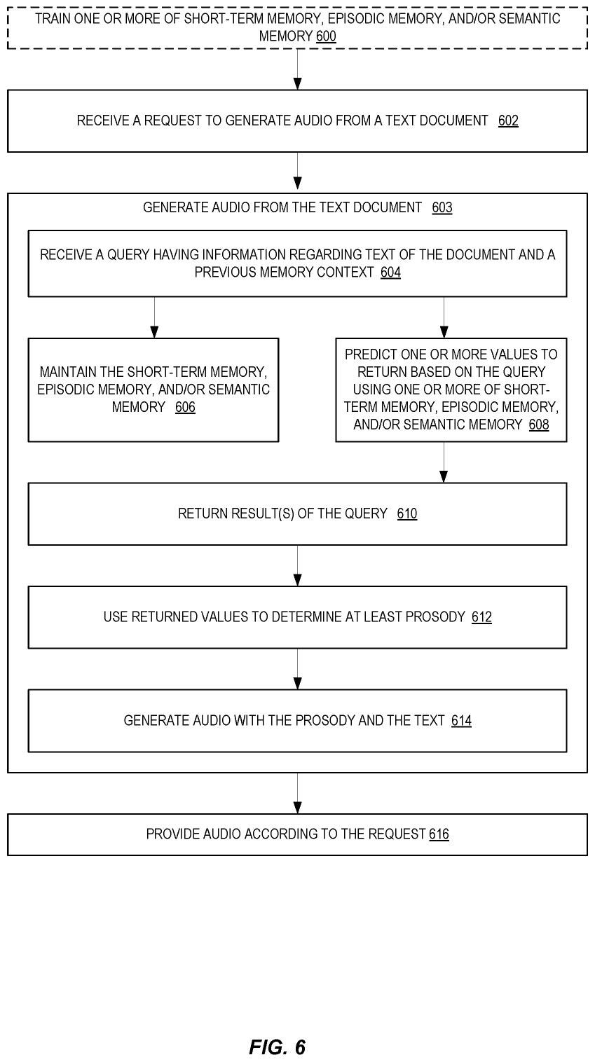

FIG. 6 is a flow diagram illustrating operations of a method for using memory in neural networks to maintain state according to some embodiments. Some or all of the operations (or other processes described herein, or variations, and/or combinations thereof) are performed under the control of one or more computer systems configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some embodiments, one or more (or all) of the operations are performed by at least the neural network memory system of the other figures.

In some embodiments, one or more of short-term memory, episodic memory, and/or semantic memory are trained at 600. For example, in some embodiments, the language model 401, attention mechanism 403, etc. of the short-term memory manager 303 are trained. In some embodiments, this training includes determining how many slots, etc. are available. In some embodiments, the training includes training the compression function 502 according to a loss function (e.g., an L1 or L2 loss function).

In some embodiments, a request to generate audio from a text document is received at 602. This request may include one or more of: a location of the text, the text, an indication of a voice to use for the audio, a speed for the audio, a location of the user making the request, a type of audio file to generate, etc.

At 603, audio from the text document is generated. At 604, a query having information regarding text (e.g., input text or a location of input text) and a previous memory context is received. For example, a query from a neural component is received.

In some embodiments, the short-term memory, episodic memory, and/or semantic memory is/are maintained at 606 based on the received query. For example, the received text may cause operations such as a discard of data from short-term memory 304 to long-term memory, the storage for a representation of the received text, the storage of the received text, the generation of a key, etc.

At 608, one or more values to return are predicted based on the query using one or more of the short-term memory, episodic memory, and/or semantic memory. The query is typically applied against all of these memories and each returns a value. For long-term memory, potential keys are looked up and a weighted value is returned. In some embodiments, a query to semantic memory causes a resolution of any pronouns (entities) in the text and search of one or more entity relationship graphs for the resolved pronouns (entities). Relevant facts for a given entity are returned. In some embodiments, a query to episodic memory includes input text and/or evicted text from short-term memory. Queries to short-term memory have been detailed above.

A result or results of the query are returned at 610. In some embodiments, the results from each of the memories are concatenated (or otherwise combined) prior to return.

In some embodiments, a neural component uses the returned values to determine at least prosody at 612.

Audio is generated with the prosody and text at 614, as dictated by the audio generation request, and provided according to the request at 616.

FIG. 7 is a flow diagram illustrating operations of a method for maintaining short-term memory according to some embodiments. Some or all of the operations (or other processes described herein, or variations, and/or combinations thereof) are performed under the control of one or more computer systems configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some embodiments, one or more (or all) of the operations are performed by at least the neural network memory system of the other figures. This discussion is when heuristic memory is used.

At 702, input text from a query is received.

A language model (such as BERT) is applied to the input text and, if available, previously stored text, to extract semantic information about the input text as a vector at 704. This output may be called “b #” where the #is the query number.

A similarity between the vector and stored vectors (keys) is made use using attention at 706. For example, the similarity between B3 (if B3 was the result of the application of the language model) and previous output of the language model (e.g., b0, b1, and b2). The attention mechanism may be a dot product.

A probability distribution for the similarities (e.g., apply SoftMax) is made at 708. The respective probabilities are then weighted by their keys at 710.

The weighted keys are summed and combined (e.g., append) to the vector to generate a value at 712. The value is output at 714.

In some embodiments, the input text, calculated probabilities, and previous text are stored, evicted, etc. according to a caching algorithm (e.g., least expected usage, least recently used, etc.) at 716.

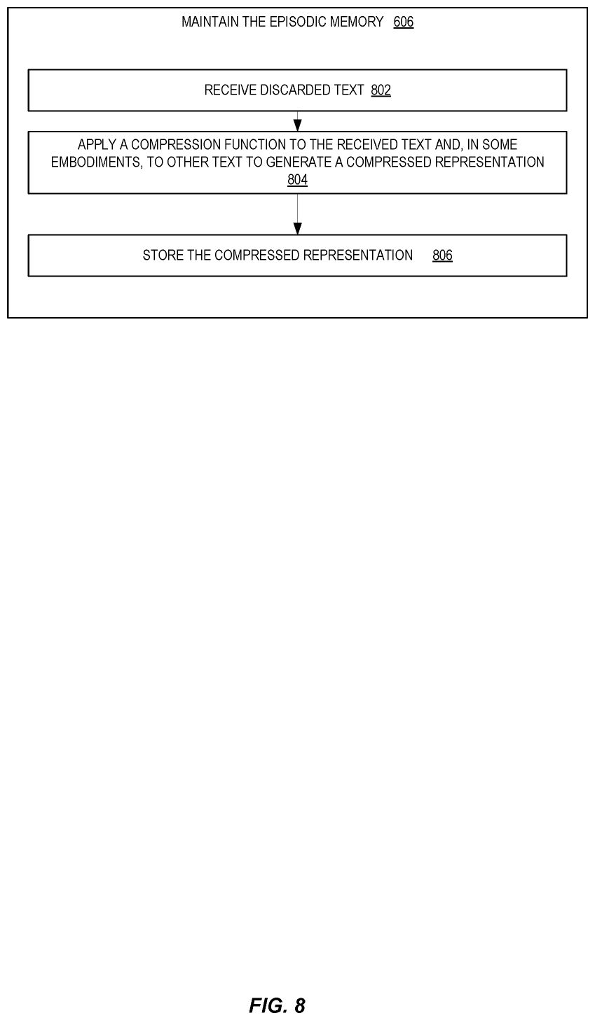

FIG. 8 is a flow diagram illustrating operations of a method for maintaining episodic memory according to some embodiments. Some or all of the operations (or other processes described herein, or variations, and/or combinations thereof) are performed under the control of one or more computer systems configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some embodiments, one or more (or all) of the operations are performed by at least the neural network memory system of the other figures. In this example, the episodic memory uses incremental updates.

At 802, discarded text is received. For example, whatever caching algorithm short-term memory uses caused this text to be evicted. In addition to the text, in some embodiments, a key for the text is also received.

In some embodiments, a compression function is to the received text and, in some embodiments, to other stored text to generate a compressed representation at 804. For example, when the stored text is in the same paragraph it is used in the compression in some embodiments. In other embodiments, the location of the received text and stored text do not impact what is used in compression. The compressed representation is stored at 806.

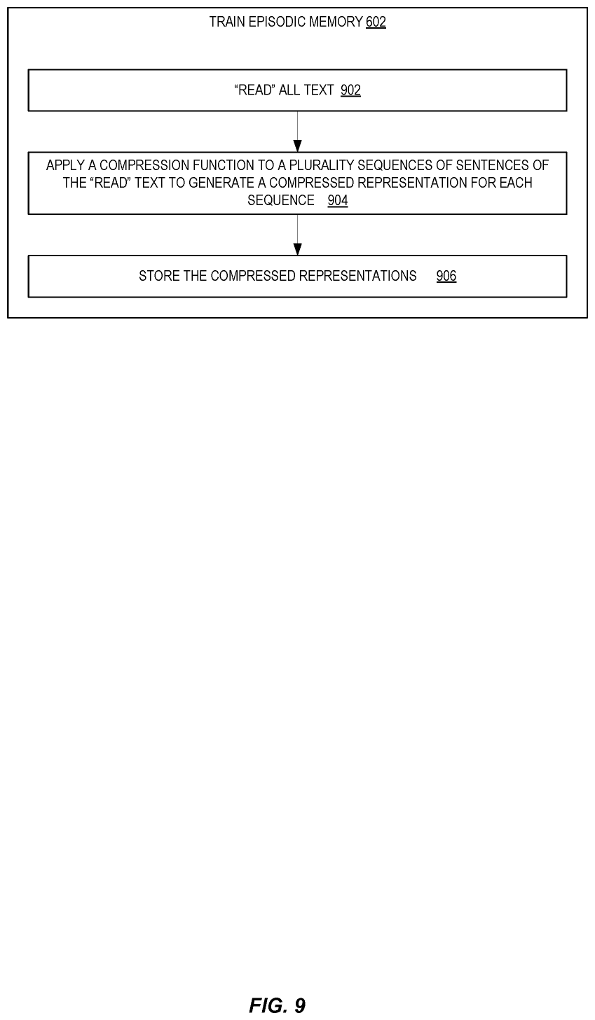

FIG. 9 is a flow diagram illustrating operations of a method for training episodic memory according to some embodiments. Some or all of the operations (or other processes described herein, or variations, and/or combinations thereof) are performed under the control of one or more computer systems configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some embodiments, one or more (or all) of the operations are performed by at least the neural network memory system of the other figures.

At 902, all text is “read.” That is the text of the book, article, etc. that is to be converted to audio is received as input to be processed.

A compression function is applied to a plurality sequences of sentences of the “read” text to generate a compressed representation for each sequence at 904.

The compressed representations are stored at 906.

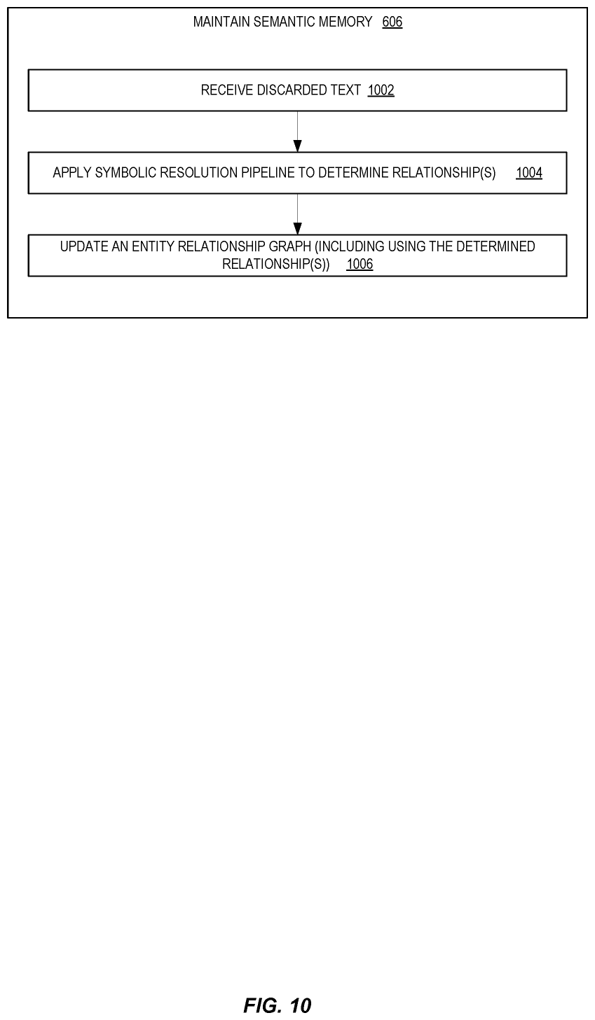

FIG. 10 is a flow diagram illustrating operations of a method for maintaining semantic memory according to some embodiments. Some or all of the operations (or other processes described herein, or variations, and/or combinations thereof) are performed under the control of one or more computer systems configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some embodiments, one or more (or all) of the operations are performed by at least the neural network memory system of the other figures.

At 1002. discarded text from short-term memory is received.

A symbolic resolution pipeline is applied to determine relationships within the text at 1004. These relationships may solely be intratext or may be to entities in a relationship graph.

An entity relationship graph is updated at 1006. Note that the determined relationships are used to update the graph when there are determined relationships. Otherwise, a node may be added to the graph for later use. In some embodiments, nodes in the graph include timestamps of updates.

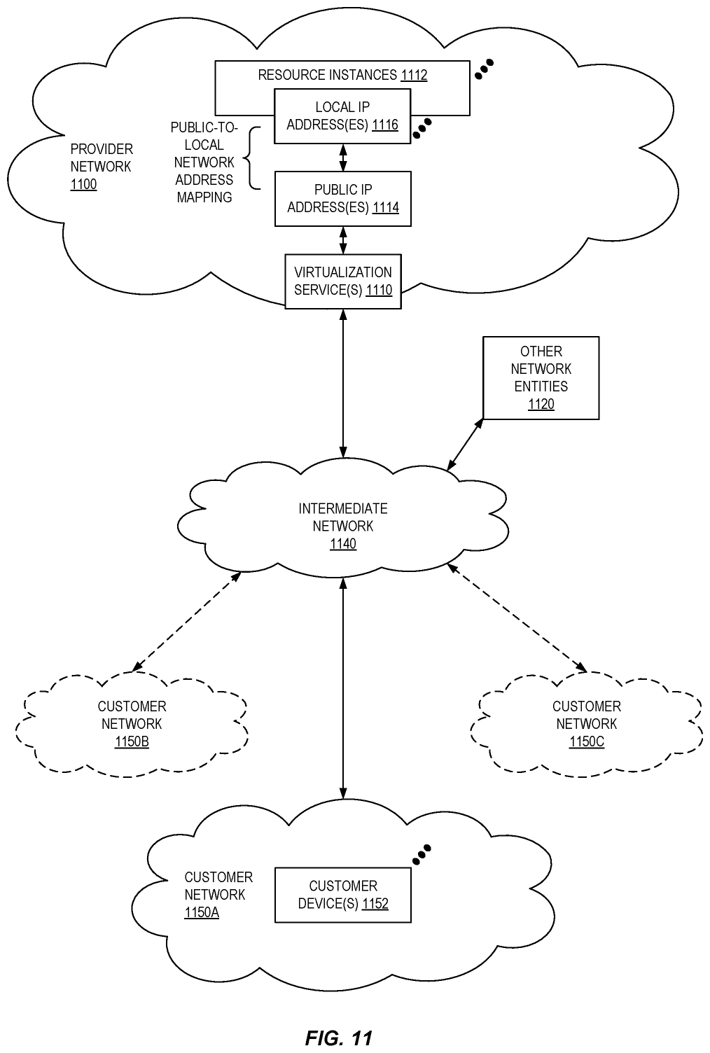

FIG. 11 illustrates an example provider network (or “service provider system”) environment according to some embodiments. A provider network 1100 can provide resource virtualization to customers via one or more virtualization services 1110 that allow customers to purchase, rent, or otherwise obtain instances 1112 of virtualized resources, including but not limited to computation and storage resources, implemented on devices within the provider network or networks in one or more data centers. Local Internet Protocol (IP) addresses 1116 can be associated with the resource instances 1112; the local IP addresses are the internal network addresses of the resource instances 1112 on the provider network 1100. In some embodiments, the provider network 1100 can also provide public IP addresses 1114 and/or public IP address ranges (e.g., Internet Protocol version 4 (IPv4) or Internet Protocol version 6 (IPv6) addresses) that customers can obtain from the provider 1100.

Conventionally, the provider network 1100, via the virtualization services 1110, can allow a customer of the service provider (e.g., a customer that operates one or more customer networks 1150A-1150C (or “client networks”) including one or more customer device(s) 1152) to dynamically associate at least some public IP addresses 1114 assigned or allocated to the customer with particular resource instances 1112 assigned to the customer. The provider network 1100 can also allow the customer to remap a public IP address 1114, previously mapped to one virtualized computing resource instance 1112 allocated to the customer, to another virtualized computing resource instance 1112 that is also allocated to the customer. Using the virtualized computing resource instances 1112 and public IP addresses 1114 provided by the service provider, a customer of the service provider such as the operator of the customer network(s) 1150A-1150C can, for example, implement customer-specific applications and present the customer's applications on an intermediate network 1140, such as the Internet. Other network entities 1120 on the intermediate network 1140 can then generate traffic to a destination public IP address 1114 published by the customer network(s) 1150A-1150C; the traffic is routed to the service provider data center, and at the data center is routed, via a network substrate, to the local IP address 1116 of the virtualized computing resource instance 1112 currently mapped to the destination public IP address 1114. Similarly, response traffic from the virtualized computing resource instance 1112 can be routed via the network substrate back onto the intermediate network 1140 to the source entity 1120.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some embodiments, the mapping of a standard IP address to a local IP address of a resource instance is the default launch configuration for all resource instance types.

At least some public IP addresses can be allocated to or obtained by customers of the provider network 1100; a customer can then assign their allocated public IP addresses to particular resource instances allocated to the customer. These public IP addresses can be referred to as customer public IP addresses, or simply customer IP addresses. Instead of being assigned by the provider network 1100 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

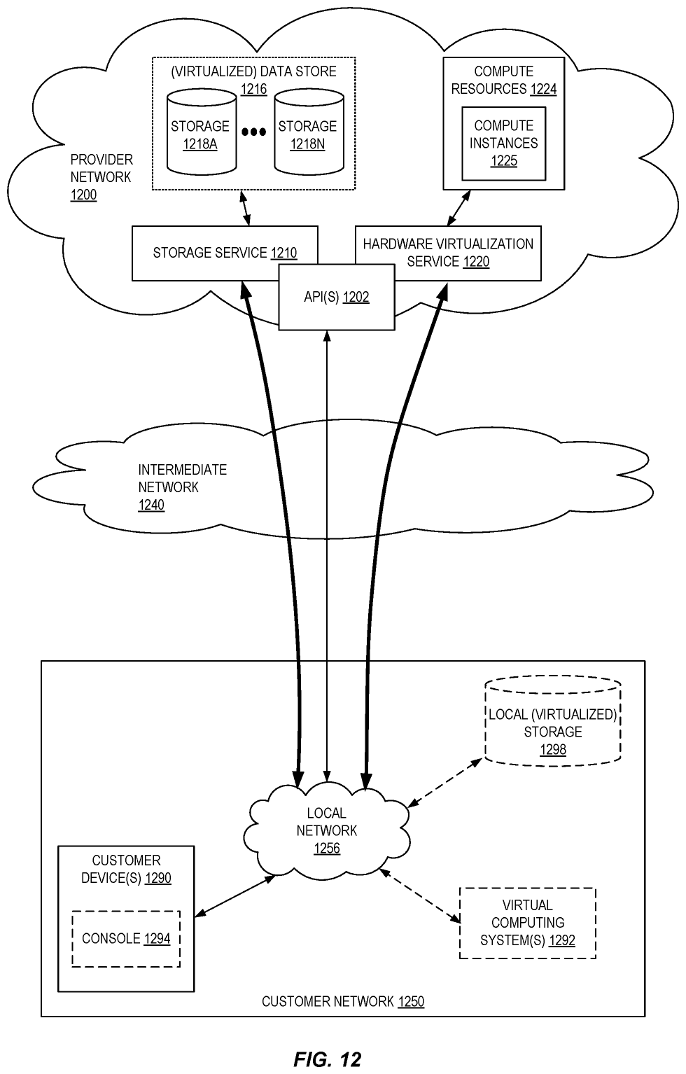

FIG. 12 is a block diagram of an example provider network environment that provides a storage service and a hardware virtualization service to customers, according to some embodiments. A hardware virtualization service 1220 provides multiple compute resources 1224 (e.g., compute instances 1225, such as VMs) to customers. The compute resources 1224 can, for example, be provided as a service to customers of a provider network 1200 (e.g., to a customer that implements a customer network 1250). Each computation resource 1224 can be provided with one or more local IP addresses. The provider network 1200 can be configured to route packets from the local IP addresses of the compute resources 1224 to public Internet destinations, and from public Internet sources to the local IP addresses of the compute resources 1224.

The provider network 1200 can provide the customer network 1250, for example coupled to an intermediate network 1240 via a local network 1256, the ability to implement virtual computing systems 1292 via the hardware virtualization service 1220 coupled to the intermediate network 1240 and to the provider network 1200. In some embodiments, the hardware virtualization service 1220 can provide one or more APIs 1202, for example a web services interface, via which the customer network 1250 can access functionality provided by the hardware virtualization service 1220, for example via a console 1294 (e.g., a web-based application, standalone application, mobile application, etc.) of a customer device 1290. In some embodiments, at the provider network 1200, each virtual computing system 1292 at the customer network 1250 can correspond to a computation resource 1224 that is leased, rented, or otherwise provided to the customer network 1250.

From an instance of the virtual computing system(s) 1292 and/or another customer device 1290 (e.g., via console 1294), the customer can access the functionality of a storage service 1210, for example via the one or more APIs 1202, to access data from and store data to storage resources 1218A-1218N of a virtual data store 1216 (e.g., a folder or “bucket,” a virtualized volume, a database, etc.) provided by the provider network 1200. In some embodiments, a virtualized data store gateway (not shown) can be provided at the customer network 1250 that can locally cache at least some data, for example frequently accessed or critical data, and that can communicate with the storage service 1210 via one or more communications channels to upload new or modified data from a local cache so that the primary store of data (the virtualized data store 1216) is maintained. In some embodiments, a user, via the virtual computing system 1292 and/or another customer device 1290, can mount and access virtual data store 1216 volumes via the storage service 1210 acting as a storage virtualization service, and these volumes can appear to the user as local (virtualized) storage 1298.

While not shown in FIG. 12, the virtualization service(s) can also be accessed from resource instances within the provider network 1200 via the API(s) 1202. For example, a customer, appliance service provider, or other entity can access a virtualization service from within a respective virtual network on the provider network 1200 via the API(s) 1202 to request allocation of one or more resource instances within the virtual network or within another virtual network.

Illustrative Systems

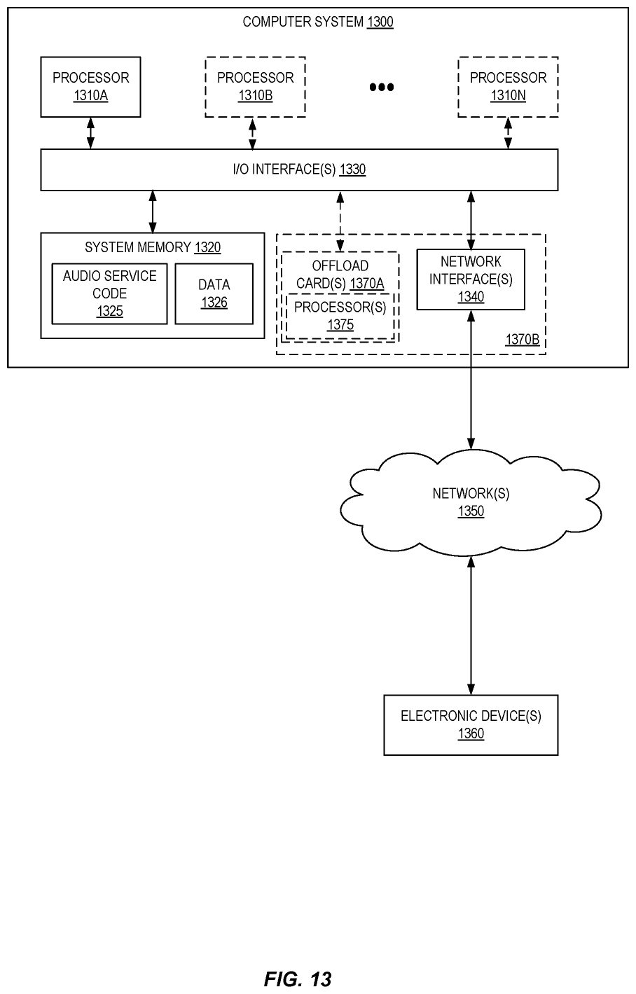

In some embodiments, a system that implements a portion or all of the techniques described herein can include a general-purpose computer system, such as the computer system 1300 illustrated in FIG. 13, that includes, or is configured to access, one or more computer-accessible media. In the illustrated embodiment, the computer system 1300 includes one or more processors 1310 coupled to a system memory 1320 via an input/output (I/O) interface 1330. The computer system 1300 further includes a network interface 1340 coupled to the I/O interface 1330. While FIG. 13 shows the computer system 1300 as a single computing device, in various embodiments the computer system 1300 can include one computing device or any number of computing devices configured to work together as a single computer system 1300.

In various embodiments, the computer system 1300 can be a uniprocessor system including one processor 1310, or a multiprocessor system including several processors 1310 (e.g., two, four, eight, or another suitable number). The processor(s) 1310 can be any suitable processor(s) capable of executing instructions. For example, in various embodiments, the processor(s) 1310 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 1310 can commonly, but not necessarily, implement the same ISA.

The system memory 1320 can store instructions and data accessible by the processor(s) 1310. In various embodiments, the system memory 1320 can be implemented using any suitable memory technology, such as random-access memory (RAM), static RAM (SRAM), synchronous dynamic RAM (SDRAM), nonvolatile/Flash-type memory, or any other type of memory. In the illustrated embodiment, program instructions and data implementing one or more desired functions, such as those methods, techniques, and data described above, are shown stored within the system memory 1320 as audio service code 1325 (e.g., executable to implement, in whole or in part, the audio service 114) and data 1326.

In some embodiments, the I/O interface 1330 can be configured to coordinate I/O traffic between the processor 1310, the system memory 1320, and any peripheral devices in the device, including the network interface 1340 and/or other peripheral interfaces (not shown). In some embodiments, the I/O interface 1330 can perform any necessary protocol, timing, or other data transformations to convert data signals from one component (e.g., the system memory 1320) into a format suitable for use by another component (e.g., the processor 1310). In some embodiments, the I/O interface 1330 can include support for devices attached through various types of peripheral buses, such as a variant of the Peripheral Component Interconnect (PCI) bus standard or the Universal Serial Bus (USB) standard, for example. In some embodiments, the function of the I/O interface 1330 can be split into two or more separate components, such as a north bridge and a south bridge, for example. Also, in some embodiments, some or all of the functionality of the I/O interface 1330, such as an interface to the system memory 1320, can be incorporated directly into the processor 1310.

The network interface 1340 can be configured to allow data to be exchanged between the computer system 1300 and other devices 1360 attached to a network or networks 1350, such as other computer systems or devices as illustrated in FIG. 1, for example. In various embodiments, the network interface 1340 can support communication via any suitable wired or wireless general data networks, such as types of Ethernet network, for example. Additionally, the network interface 1340 can support communication via telecommunications/telephony networks, such as analog voice networks or digital fiber communications networks, via storage area networks (SANs), such as Fibre Channel SANs, and/or via any other suitable type of network and/or protocol.

In some embodiments, the computer system 1300 includes one or more offload cards 1370A or 1370B (including one or more processors 1375, and possibly including the one or more network interfaces 1340) that are connected using the I/O interface 1330 (e.g., a bus implementing a version of the Peripheral Component Interconnect-Express (PCI-E) standard, or another interconnect such as a QuickPath interconnect (QPI) or UltraPath interconnect (UPI)). For example, in some embodiments the computer system 1300 can act as a host electronic device (e.g., operating as part of a hardware virtualization service) that hosts compute resources such as compute instances, and the one or more offload cards 1370A or 1370B execute a virtualization manager that can manage compute instances that execute on the host electronic device. As an example, in some embodiments the offload card(s) 1370A or 1370B can perform compute instance management operations, such as pausing and/or un-pausing compute instances, launching and/or terminating compute instances, performing memory transfer/copying operations, etc. These management operations can, in some embodiments, be performed by the offload card(s) 1370A or 1370B in coordination with a hypervisor (e.g., upon a request from a hypervisor) that is executed by the other processors 1310A-1310N of the computer system 1300. However, in some embodiments the virtualization manager implemented by the offload card(s) 1370A or 1370B can accommodate requests from other entities (e.g., from compute instances themselves), and cannot coordinate with (or service) any separate hypervisor.

In some embodiments, the system memory 1320 can be one embodiment of a computer-accessible medium configured to store program instructions and data as described above. However, in other embodiments, program instructions and/or data can be received, sent, or stored upon different types of computer-accessible media. Generally speaking, a computer-accessible medium can include any non-transitory storage media or memory media such as magnetic or optical media, e.g., disk or DVD/CD coupled to the computer system 1300 via the I/O interface 1330. A non-transitory computer-accessible storage medium can also include any volatile or non-volatile media such as RAM (e.g., SDRAM, double data rate (DDR) SDRAM, SRAM, etc.), read only memory (ROM), etc., that can be included in some embodiments of the computer system 1300 as the system memory 1320 or another type of memory. Further, a computer-accessible medium can include transmission media or signals such as electrical, electromagnetic, or digital signals, conveyed via a communication medium such as a network and/or a wireless link, such as can be implemented via the network interface 1340.

Various embodiments discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most embodiments use at least one network that would be familiar to those skilled in the art for supporting communications using any of a variety of widely-available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In embodiments using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle®, Microsoft®, Sybase®, IBM®, etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of embodiments, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate embodiments can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

In the preceding description, various embodiments are described. For purposes of explanation, specific configurations and details are set forth in order to provide a thorough understanding of the embodiments. However, it will also be apparent to one skilled in the art that the embodiments can be practiced without the specific details. Furthermore, well-known features can be omitted or simplified in order not to obscure the embodiment being described.

Bracketed text and blocks with dashed borders (e.g., large dashes, small dashes, dot-dash, and dots) are used herein to illustrate optional operations that add additional features to some embodiments. However, such notation should not be taken to mean that these are the only options or optional operations, and/or that blocks with solid borders are not optional in certain embodiments.

Reference numerals with suffix letters (e.g., 1218A-1218N) can be used to indicate that there can be one or multiple instances of the referenced entity in various embodiments, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various embodiments.

References to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Moreover, in the various embodiments described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given embodiment requires at least one of A, at least one of B, and at least one of C to each be present.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

The specification and drawings are, accordingly, to be regarded in an illustrative rather than a restrictive sense. It will, however, be evident that various modifications and changes can be made thereunto without departing from the broader spirit and scope of the disclosure as set forth in the claims.

What is claimed is:

1. A computer-implemented method comprising:
receiving a request to generate audio for text from a document;
receiving a query having text and previous contextual information;
querying a short-term memory storing fine-grained information for recent text of the document and receiving a first value in response;
querying an episodic long-term memory storing information discarded from the short-term memory in a compressed form and receiving a second value in response;
querying a semantic long-term memory storing relevant facts per entity in the document in one or more relationship graphs and receiving a third value in response;
providing the first, second, and third values to a neural network to generate audio;
generating audio using the neural network; and
providing the audio according to the request.

2. The computer-implemented method of claim 1, wherein the request includes at least one of: a location of the document, the document, an indication of a voice to use for the audio, a speed for the audio, a location of a user making the request, and a type of audio file to generate.

3. The computer-implemented method of claim 1, wherein the short-term memory utilizes a caching algorithm of one of: least recently used, least important, least frequently used, last in first out, and first in first out.

4. A computer-implemented method comprising:
receiving a query having text and previous contextual information;
querying one or more of:
a short-term memory storing fine-grained information for recent text of a document and receiving a first value in response,
an episodic long-term memory storing information discarded from the short-term memory in a compressed form and receiving a second value in response, and
a semantic long-term memory storing relevant facts per entity in the document and receiving a third value in response, and
providing at least one of the first, second, and third values to a neural network to generate audio.

5. The computer-implemented method of claim 4, further comprising:
maintaining the short-term memory by:
applying a language model to the text to generate a vector,
computing a similarity between the vector and stored vectors,
calculating a probability distribution for the similarities,
weighting the stored vectors by their respective probability distribution,
summing the weighted vectors and combining with the vector to generate a value,
evicting a stored vector according to a caching algorithm, and
storing the vector according to the caching algorithm.

6. The computer-implemented method of claim 5, wherein the caching algorithm is one of: least recently used, least important, least frequently used, last in first out, and first in first out.

7. The computer-implemented method of claim 4, further comprising:
maintaining the episodic long-term memory by:
receiving text discarded from the short-term memory,
applying a compression function to the received text to generate a compressed representation, and
storing the compressed representation.

8. The computer-implemented method of claim 4, further comprising:
training the episodic long-term memory by:
reading all text of the document,
applying a compression function to the sequences of sentences of the document generate a compressed representation for each sequence, and
storing the compressed representations.

9. The computer-implemented method of claim 4, wherein the episodic long-term memory uses similarity-based compression.

10. The computer-implemented method of claim 4, wherein all evicted text in the same paragraph is stored together in the episodic long-term memory.

11. The computer-implemented method of claim 4, further comprising:
maintaining the semantic long-term memory by:
resolving pronouns for text evicted from the short-term memory,
extracting relationship information for the resolved pronouns, and
updating an entity relationship graph based on the extracted relationship information.

12. The computer-implemented method of claim 11, wherein the entity relationship graph stores information in symbolic form.

13. The computer-implemented method of claim 4, further comprising:
using the returned values to determine prosody.

14. The computer-implemented method of claim 4, wherein the audio is generated in response to a request including at least one of a location of the document, the document, an indication of a voice to use for the audio, a speed for the audio, a location of a user making the request, and a type of audio file to generate.

15. A system comprising:
a first one or more electronic devices to implement storage in a multi-tenant provider network; and
a second one or more electronic devices to implement an audio service in the multi-tenant provider network, the audio service including instructions that upon execution cause the audio service to:
receive a query having text from a document stored in the storage and previous contextual information;
query one or more of:
a short-term memory storing fine-grained information for recent text of a document and receiving a first value in response,
an episodic long-term memory storing information discarded from the short-term memory in a compressed form and receiving a second value in response, and
a semantic long-term memory storing relevant facts per entity in the document and receiving a third value in response; and
provide at least one of the first, second, and third values to a neural network of the audio service to generate audio.

16. The system of claim 15, wherein the audio service is further to maintain the short-term memory by:
applying a language model to the text to generate a vector,
computing a similarity between the vector and stored vectors,
calculating a probability distribution for the similarities,
weighting the stored vectors by their respective probability distribution,
summing the weighted vectors and combining with the vector to generate a value,
evicting a stored vector according to a caching algorithm, and
storing the vector according to the caching algorithm.

17. The system of claim 16, wherein the caching algorithm is one of least recently used, least important, least frequently used, last in first out, and first in first out.

18. The system of claim 15, wherein the audio service is further to maintain the episodic long-term memory by:
receiving text discarded from the short-term memory,
applying a compression function to the received text to generate a compressed representation, and
storing the compressed representation.

19. The system of claim 15, wherein all evicted text in the same paragraph is stored together in the episodic long-term memory.

20. The system of claim 15, wherein the audio is generated in response to a request including at least one of a location of the document, the document, an indication of a voice to use for the audio, a speed for the audio, a location of a user making the request, and a type of audio file to generate.
